(19) United States
(12) Patent Application Publication
(10) Pub. No.: US 2005/0272911 A1
(43) Pub. Date: Dec. 8, 2005

(54) Method for producing polyether polyol

(75) Inventors: Toru Okoshi, Kanagawa (JP); Tohru Setoyama, Kanagawa (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: MITSUBISHI CHEMICAL CORPORATION, Tokyo (JP)

(21) Appl. No.: 11/134,460

(22) Filed: May 23, 2005

Related U.S. Application Data
(63) Continuation of application No. PCT/JP03/13650, filed on Oct. 24, 2003.

(30) Foreign Application Priority Data
Nov. 22, 2002 (JP) P. 2002-339507

(51) Int. Cl. C08G 18/10

(52) U.S. Cl. 528/425

(57) ABSTRACT

The object of the present invention is to provide a method for producing a polyether polyol which is little colored and has a high degree of polymerization in high yield by a dehydration-condensation of a polyol. In the present invention, a dehydration-condensation reaction is carried out in the presence of a catalyst composed of an acid and a base.

### FIELD OF THE INVENTION

The present invention relates to a method for producing a polyether polyol by a dehydration-condensation reaction of a polyol. More particularly, the present invention relates to a method in which a reaction is carried out in the presence of a novel catalyst.

### BACKGROUND ART

Polyether polyols are polymers having a wide range of uses including their use as a raw material for soft segments such as elastic fibers, plastic elastomers. Polyethylene glycol, poly(1,2-propanediol) and poly(tetramethylene ether)glycol are known as typical polyether polyols. Among these, poly(1,2-propanediol) is, widely used, since it is a liquid at room temperature and is easy to handle and is inexpensive. As poly(1,2-propanediol) contains a primary hydroxyl group and a secondary hydroxyl group, however, a difference in physical properties between those hydroxyl groups becomes a problem, depending on its use. On the other hand, poly(trimethylene ether)glycol, which is a product by a dehydration-condensation of 1,3-propanediol, has recently come to draw attention, since it contains only a primary hydroxyl group and also has a low melting point.

Polyether polyols can generally be produced by a dehydration-condensation reaction of the corresponding polyols. However, ethylene glycol, 1,4-butanediol and 1,5-pentanediol, for example, produce upon dehydration-condensation five- or six-member ring cyclic ethers, i.e. 1,4-dioxane, tetrahydrofuran and tetrahydropyran, respectively. Accordingly, polyether polyol corresponding to a polymer of ethylene glycol, 1,4-butanediol is produced by the ring-opening polymerization of the corresponding cyclic ethers, namely ethylene oxide and tetrahydrofuran, respectively. Polyether polyol corresponding to a polymer of 1,5-pentanediol is difficult to obtain, since tetrahydropyran which is a cyclic ether is thermodynamically beneficial.

The production of a polyether polyol by a dehydration-condensation reaction of a polyol is generally carried out by using an acid catalyst. As the catalyst, there are proposed iodine, inorganic acids such as hydrogen iodide, sulfuric acid, and organic acids such as paratoluenesulfonic acid (see Patent Document 1), a resin having a perfluoro-alkylsulfonate group in a side chain (see Patent Document 2), sulfuric acid, activated clay, zeolite, an organic sulfonic acid, a heteropolyacid and combinations thereof with cuprous chloride (see Patent Literature 3), etc.

Regarding a method for reaction, there is proposed a method in which a dehydration-condensation reaction is first carried out in a nitrogen atmosphere and is followed by a dehydration-condensation reaction at a reduced pressure (see Patent Document 4). The methods as hitherto proposed, however, necessitate a reaction at high temperature or long hours of reactions for producing a polyether polyol having a high degree of polymerization, and the polyether polyol thereby obtained have the problem of being colored.

[Patent Document 1]

Description of U.S. Pat. No. 2,520,733

[Patent Document 2]

Pamphlet of International Publication WO 92/09647

[Patent Document 3]

Description of U.S. Pat. No. 5,659,089

[Patent Document 4]

Description of US-A-2002/0007043

### DISCLOSURE OF THE INVENTION

Therefore, an object of the present invention is to provide a method for producing a polyether polyol which is little colored and has a high degree of polymerization in high yield by a dehydration condensation of a polyether polyol under moderate reaction conditions.

The present inventors made intensive investigations and found that the object as above can be attained by using a specific system of a catalyst. The invention has been thus completed.

Thus, the present invention resides essentially in a method for producing a polyether polyol by the dehydration-condensation reaction of a polyol, wherein a reaction is carried out in the presence of a catalyst comprising an acid and a base.

### BEST MODE FOR CARRYING OUT THE INVENTION

The acid in the catalyst used in the present invention may be any one hitherto known as producing an ether bond by the dehydration-condensation reaction of an alcoholic hydroxyl group. The acid may be either-one dissolved in a reaction system and functioning as a homogeneous catalyst, or one not dissolved therein, but functioning as a heterogeneous catalyst. Examples of the former are sulfuric acid, phosphoric acid, fluorosulfuric acid, hetero polyacids such as phosphotungstic acid, alkylsulfonic acids which may has a fluorinated alkyl chain such as methanesulfonic acid, trifluoromethanesulfonic acid, octanesulfonic acid, 1,1,2,2-tetrafluoroethane-sulfonic acid, benzenesulfonic acid and benzenesulfonic acid which may have an alkyl side chain, arylsulfonic acids such as paratoluenesulfonic acid. Moreover, examples of the latter are activated clay, zeolite, silica-alumina, silica-zirconia and other mixed metal oxides, and a resin having a perfluoroalkylsulfonate group in a side chain.

Among those, sulfuric acid, phosphoric acid, benzenesulfonic acid and paratoluenesulfonic acid and the like are preferred because of their easy availability and low prices, and sulfuric acid is particularly preferred.

As the base in the catalyst, an organic base and an alkali metal are preferred, and the organic base is particularly preferred.

A nitrogen-containing organic base, particularly a nitrogen-containing organic base having a tertiary nitrogen atom, is preferred as the organic base in the catalyst. Some examples are a nitrogen-containing heterocylic compound having the pyridine skeleton such as pyridine, picoline, quinoline, a nitrogen-containing heterocyclic compound having a N—C═N bond such as N-methylimidazole, 1,5-diazabicyclo[4. 3. 0]-5-nonene, 1,8-diazabicyclo[5. 4. 0]-7-undecene, and trialkylamine such as triethylamine, tributylamine. Among those, preferred are one having the pyridine skeleton and a nitrogen-containing heterocyclic compound having an N—C═N bond, and pyridine is particularly preferred because of its easy availability and low price.

The organic base is used in less than an equivalent relative to the acid in the catalyst, namely in an equivalent ratio wherein it does not neutralize all of the acid in the catalyst. It is used in an amount of preferably 0.01 equivalent or more and more preferably 0.05 equivalent or more, and 0.9 equivalent or less and more preferably 0.5 equivalent or less, to the acid in the catalyst.

The above acid and organic base may be present separately in a reaction system, or may form a salt. It is also possible to use a salt formed by the acid and organic base beforehand.

Li, Na, K and Cs are preferred as the alkali metal which is the base in the catalyst, and Na is particularly preferred. When an alkali metal is used, an alkali metal salt formed by the alkali metal and the acid in the catalyst is preferably used.

Examples of the alkali metal salts are a mineral acid salt such as sulfate, hydrogen sulfate, halide, phosphate, hydrogen phosphate, borate, organic sulfonate such as trifluoromethanesulfonate, paratoluenesulfonate, methanesulfonate, carboxylate such as format, acetate. It is preferable that an alkali metal salt and a free acid coexist in the reaction-system, and in this connection, it is preferable that the acid forming the alkali metal salt and the free acid are the same.

While an acid which is a catalyst and an alkali metal salt thereof may be used respectively, it is also possible to react a carbonate of an alkali metal, hydrogen carbonate of an alkali metal or hydroxide of an alkali metal, a simple substance of the metal, etc. with an acid which is a catalyst and thereby prepare a catalyst comprising the desired acid and alkali metal salt. For example, it is possible to react a carbonate of an alkali metal with sulfuric acid in a polyol which is a reaction substrate, and thereby produce a solution containing sulfuric acid and an alkali metal sulfate.

The alkali metal salt is used in an amount of preferably 0.01 equivalent or more and more preferably 0.05 equivalent or more, and preferably 0.9 equivalent or less and more preferably 0.5 equivalent or less, to the acid in a catalyst.

Referring to the polyol which is a raw material for reaction, it is preferable to use a diol having two primary hydroxyl groups, such as 1,3-propanediol, 2-methyl-1,3-propanediol, 2,2-dimethyl-1,3-propanediol, 1,6-hexanediol, 1,7-heptanediol, 1,8-octanediol, 1,9-nonanediol, 1,10-decanediol or 1,4-cyclohexanedimethanol. Despite diols having two primary hydroxyl groups, however, ethylene glycol, 1,4-butanediol, 1,5-pentanediol, etc. are not desirable as a raw material for the method of the present invention, since the dehydration-condensation reaction thereof produces a cyclic ether, as stated before.

Although these diols each is usually used independently, it is also possible to use a mixture of two or more diols, if desired. In any such event, however, it is preferable for the main diol to occupy 50 mole % or more. It is also possible to use with those diols an oligomer, or any of a dimer to a nonamer, as obtained by the dehydration-condensation reaction of the main diol. Moreover, it is also possible to use together a polyol which is a triol or more, such as trimethylolethane, trimethylolpropane or pentaerythritol, or an oligomer of any such polyol.

In any such event, however, it is preferable for the main diol to occupy 50 mole % or more. It is usual to employ for the reaction a diol having two primary hydroxyl groups and 3 to 10 carbon atoms with another polyol occupying a proportion of less than 50 mole % therein, excluding any forming a five- or six-member ring cyclic ether by the dehydration-condensation reaction, such as 1,4-butanediol and 1,5-pentanediol, or a mixture thereof. It is preferable to employ for the reaction a diol selected from the group consisting of 1,3-propanediol, 2-methyl-1,3-propanediol and 2,2-dimethyl-1,3-propanediol, or a mixture thereof with another polyol occupying a proportion of less than 50 mole % therein.

The production of a polyether polyol by the dehydration-condensation reaction of a polyol according to the method of the present invention may be carried out either by a batch or a continuous type operation. In the case of the batch type operation, a polyol as a raw material and an acid and a base in a catalyst are charged into a reactor and reacted under stirring. In the case of the continuous reaction, it is possible to use a method in which a polyol as a raw material and a catalyst are continuously supplied into, for example, a reactor having a multiplicity of stirring tanks installed in series, or a flow reactor at one end thereof, and are moved through the reactor in a piston flow or in a way close thereto, while the reaction liquid is continuously discharged through the other end thereof.

The acid for the catalyst is usually employed in an amount of 0.001 to 0.3 times larger by weight than the polyol as the raw material. If the acid acts as a homogeneous catalyst, it is preferably used in an amount of 0.001 to 0.1 time larger by weight. In the case of the continuous reaction, and in the case of using an acid acting as a heterogeneous catalyst like a resin having a perfluoroalkylsulfonate group in its side chain, it is possible to adopt a method in which it is left to stay in the reactor without being discharged with the reaction liquid, and is continuously supplied with the polyol as the raw material. In such a case, it is usual to supply the polyol as the raw material in an amount per hour of at least usually 0.1 time and preferably 1 time larger by weight, and at most usually 10,000 times and preferably 1,000 times larger by weight than the acid staying in the reactor. As in such a case, the equivalent ratio of the base to the acid in the reactor is likely to drop with the passage of time, the base is supplied with the polyol as the raw material to maintain the equivalent ratio of the organic base to the acid at the desired level, if required.

As to the temperature of the dehydration-condensation reaction, it is advisable to carry out the reaction at a lower limit of usually 120° C. and preferably 140° C. and, an upper limit of usually 250° C. and preferably 200° C. The reaction is preferably carried out in an inert gas atmosphere, such as nitrogen or argon. The reaction pressure may be of any level as long as the reaction system is maintained in a liquid phase, but usually the reaction is carried out at normal pressure. It is possible to carry out the reaction at a reduced pressure, or cause an inert gas to flow through the reaction system, if desired in order to promote the separation of water produced by the reaction from the reaction system.

The reaction time depends on an amount of a catalyst used, a reaction temperature, a desired yield and physical properties of a resulting dehydration-condensation product, etc., a lower limit is usually 0.5 hour and preferably an hour and an upper limit is usually 50 hours and preferably 20 hours. The reaction is usually carried out in the absence of any solvent, though a solvent can be used, if desired. The solvent may be selected from among the organic solvents employed usually for organic synthesis reactions in view of its vapor pressure and stability under the reaction conditions, the solubility therein of the raw material and the reaction product, etc.

The separation and recovery of the polyether polyol as produced from the reaction system may be carried out in any ordinary method. When the acid acting as a heterogeneous catalyst has been used, the acid suspended in the reaction liquid is first removed from it by filtration or centrifugal separation. Then, the low-boiling oligomer and base are removed by distillation or extraction from water, whereby the intended polyether polyol is obtained.

When the acid acting as a homogeneous catalyst has been used, water is first added to the reaction liquid to divide it into a polyether polyol layer and a water layer containing the acid, base, oligomer, etc. Since a part of the polyether polyol forms an ester with the acid used as the catalyst, the reaction solvent to which water has been added is heated to cause the hydrolysis of the ester before its layer division. The hydrolysis is promoted if an organic solvent having an affinity for both the polyether polyol and water is used with water. If the polyether polyol is too high in viscosity to be easily separated, it is desirable to use an organic solvent having an affinity for the polyether polyol and easily separable from it by distillation. The polyether polyol phase obtained by the layer division is distilled to have any remaining water and organic solvent removed, whereby the intended polyether polyol is obtained. In the event that any acid remains in the polyether polyol phase obtained by the layer division, it is washed with water or an aqueous alkali solution, or treated with an anion-exchange resin, or a solid base such as calcium hydroxide to have any remaining acid removed before it is distilled.

The polyether polyol obtained by the method of the present invention has a weight-average molecular weight (Mw) ranging from a lower limit of usually 600 and preferably 1,200 to an upper limit of usually 30,000 and preferably 15,000.

The number-average molecular weight (Mn) has a lower limit of usually 500 and preferably 1,000, and has an upper limit of usually 10,000 and preferably 5,000.

The molecular weight distribution (Mw/Mn) is preferably as close to 1 as possible, and has an upper limit of usually 3 and preferably 2.5.

The Hazen color number is preferably as close to 0 as possible, and has an upper limit of usually 120 and preferably 100.

### EXAMPLES

The invention will now be described more specifically by way of examples.

(Determination of Weight-Average Molecular Weight (Mw) and Number-Average Molecular Weight (Mn))

The weight-average molecular weight (Mw) and number-average molecular weight (Mn) of the polyether polyol were determined by gel-permeation chromatography under the following conditions and calculated by using polytetrahydrofuran as a reference.

Column:

TSK-GEL GMHXL-N (7.8 mm ID×30.0 cm·L) (Toso Co., Ltd.)

Mass Calibration:

POLYTETRAHYDROFURAN CALIBRATION KIT (Polymer Laboratoris) (Mp=547000, 283000, 99900, 67500, 35500, 15000, 6000, 2170, 1600, 1300)

Solvent: Tetrahydrofuran

(Hazen Color Number)

The coloring degree of the polyether polyol was indicated by the Hazen color number as specified by the standard of Hazen Color Number American Public Health Association (APHA).

Hazen color number: Its Hazen color number was obtained by comparing it in accordance with JIS K 0071-1 with a standard liquid prepared by diluting a standard solution for APHA color number (No. 500) produced by Kishida Chemical Co.

### Example 1

### Purification by Distillation of 1,3-Propanediol

In a 200 ml four-neck flask equipped with a reflux condenser, a nitrogen introducing tube, a thermometer and a stirrer, 100.0 g of 1,3-propanediol (Reagent produced by Aldrich and having a purity of 98%, Batch# 00312JO) and 0.70 g of potassium hydroxide were added in a nitrogen atmosphere. The flask was heated in an oil bath and after a temperature of the solution was reached to 147° C., it was held at a temperature of 147 to 152° C. After two hours, the flask was removed from the oil bath and allowed to cool to room temperature. Then, simple distillation was carried out at about 100° C. and at a reduced pressure After 10 g of foreshots had been thrown away, about 80 g of distillate were recovered.

### Dehydration-Condensation Reaction of 1,3-Propanediol

In a 100 ml four-neck flask equipped with a distilling tube, a nitrogen introducing tube, a thermometer and a stirrer, 50 g of 1,3-propanediol as purified by distillation in the way described above was added, while nitrogen was being supplied at a rate of 100 Nml/min. After 0.0534 g of pyridine was added thereto, 0.697 g of concentrated sulfuric acid (95%) was added slowly under stirring. The flask was dipped in an oil bath and heated to 155° C. The solution was held at a controlled temperature of 155° C.±2° C. for eight hours to undergo reaction and the flask was removed from the oil bath and allowed to cool to room temperature. Water resulting from the reaction was removed with nitrogen. The reaction solution cooled to the room temperature was transferred into a 300 ml flask by using 50 g of tetrahydrofuran, 50 g of desalted water was added thereto, and the hydrolysis of sulfuric acid ester was carried out by a slow reflux lasting for an hour. After it had been allowed to cool to the room temperature, the lower layer (water layer) was removed from the two layers which had been separated from each other.

After 0.5 g of calcium hydroxide was added to the upper layer (oil layer), and it was stirred for an hour at room temperature, and 50 g of toluene was added thereto and it was heated to 60° C. to have tetrahydrofuran, water and toluene removed by distillation at a reduced pressure. The residue was dissolved in 100 g of toluene and its solution was filtered by a filter having a mesh size of 0.45 μm to remove any insoluble matter removed. The filtrate was heated to 60° C. and toluene was removed therefrom by distillation at a reduced pressure. The residual liquid was heated to 60° C. and left to dry for six hours in a vacuum to yield poly(trimethylene ether)glycol. The results are shown in Table 1.

### Comparative Example 1

Poly (trimethylene ether) glycol was obtained by the same method as in Example except that pyridine was not added. The results are shown in Table 1.

### Example 2

Poly (trimethylene ether) glycol was obtained by the same method as in Example except that 0.0629 g of 3-picoline was used instead of pyridine. The results are shown in Table 1.

### Example 3

Poly(trimethylene ether) glycol was obtained by the same method as in Example 1 except that 0.0554 g of N-methylimidazole was used instead of pyridine. The results are shown in Table 1.

### Example 4

Poly (trimethylene ether) glycol was obtained by the same method as in Example 1 except that 0.103 g of 1,8-diazabicyclo[5. 4. 0]-7-undecene was used instead of pyridine. The results are shown in Table 1.

### Example 5

Poly (trimethylene ether) glycol was obtained by the same method as in Example 1 except that 0.0358 g of sodium carbonate was used instead of pyridine. The results are shown in Table 1.

TABLE 1

| | | | | Hazen color | Yield |
|---|---|---|---|---|---|
| | Mn | Mw | Mw/Mn | number | (g) |
| Example 1 | 2,173 | 4,322 | 1.99 | 64 | 37.0 |
| Comparative | 1,544 | 2,830 | 1.83 | 130 | 36.9 |
| Example 1 | | | | | |
| Example 2 | 2,029 | 3,883 | 1.91 | 69 | 37.1 |
| Example 3 | 2,198 | 4,293 | 1.95 | 52 | 37.3 |
| Example 4 | 2,460 | 4,956 | 2.01 | 75 | 37.4 |
| Example 5 | 1,948 | 3,773 | 1.94 | 94 | 37.1 |

According to the method of the present invention, it is possible to obtain a polyether polyol which is less colored and has a high degree of polymerization in high yield.

While the invention has been described in detail and with reference to specific embodiments thereof, it will be apparent to one skilled in the art that various changes and modifications can be made therein without departing from the spirit and scope thereof.

This application is based on Japanese Patent Application filed on Nov. 22, 2002 (Application No. 2002-339507), of which the disclosure is incorporated herein by reference.

### INDUSTRIAL APPLICABILITY

According to the production method of the present invention, it is possible to efficiently produce a polyether polyol which is little colored and has a high degree of polymerization by a reaction under moderate conditions.

1. A method for producing a polyether polyol by a dehydration-condensation reaction of a polyol, wherein a reaction is carried out in the presence of a catalyst comprising an acid and a base.

2. The method for producing a polyether polyol according to claim 1, wherein the base in the catalyst is a nitrogen-containing organic base having a tertiary nitrogen atom.

3. The method for producing a polyether polyol according to claim 2, wherein the nitrogen-containing organic base in the catalyst has a pyridine skeleton.

4. The method for producing a polyether polyol according to claim 1, wherein the catalyst comprising an acid and a base contains an alkali metal salt.

5. The method for producing a polyether polyol according to claim 4, wherein the alkali metal salt is a salt of an alkali metal with the same acid as the acid in the catalyst.

6. The method for producing a polyether polyol according to claim 1, wherein an equivalent ratio of the base to the acid in the catalyst is from 0.01 to 0.9.

7. The method for producing a polyether polyol according to claim 1, wherein the acid in the catalyst is selected from the group consisting of sulfuric acid, phosphoric acid, fluorosulfuric acid, a heteropoly acid, a benzenesulfonic acid which may have an alkyl side chain in its ring, and an alkylsulfonic acid which may have a fluorinated alkyl chain.

8. The method for producing a polyether polyol according to claim 1, wherein the acid in the catalyst is selected from the group consisting of an activated clay, zeolite, a mixed metal oxide and a resin having a perfluoroalkylsulfonic acid group in a side chain thereof.

9. The method for producing a polyether polyol according to claim 1, wherein the polyol is a diol having two primary hydroxyl groups and 3 to 10 carbon atoms (except any that forms a five- or six-member ring cyclic ether by dehydration), or a mixture thereof with another polyol having a proportion of less than 50 mole % therein.

10. The method for producing a polyether polyol according to claim 1, wherein the polyol is a diol selected from the group consisting of 1,3-propanediol, 2-methyl-1,3-propanediol and 2,2-dimethyl-1,3-propanediol, or a mixture thereof with another polyol having a proportion of less than 50 mole % therein.

11. The method for producing a polyether polyol according to claim 1, wherein a reaction is carried out at a temperature of 120° C. to 250° C.

12. The method for producing the polyether polyol according to any one of claims 1 to 6, wherein the acid in the catalyst is selected from the group consisting of sulfuric acid, phosphoric acid, benzenesulfonic acid, and paratoluenesulfonic acid.
